(19) United States
(12) Patent Application Publication
(10) Pub. No.: US 2008/0231204 A1
(43) Pub. Date: Sep. 25, 2008

(54) Light emitting diode assembly replacement for fluorescent lamp

(76) Inventors: Michael R. Praiswater, Albuquerque, NM (US); Teddy J. Wood, Corrales, NM (US)

Correspondence Address: HONEYWELL INTERNATIONAL INC., 101 COLUMBIA ROAD, P O BOX 2245, MORRISTOWN, NJ, 07962-2245, US

(21) Appl. No.: 11/725,648

(22) Filed: Mar. 19, 2007

(51) Int. Cl. H05B 37/00

(52) U.S. Cl. 315/192; 315/185 R; 315/312

(57) ABSTRACT

A method and apparatus for replacing a fluorescent lighting system with a light emitting diode (LED) system. By connecting the LEDs in accordance with the described embodiment, the fluorescent lamp driving circuit can be reused without modification. The current rating of the LEDs must be equal to or less than the current output of the fluorescent lamp driving circuit. The LED replacement lamp may consist of as few as two LEDs but multiple LEDs may be used as long as the power consumed by the LEDs does not exceed the power rating of the fluorescent lamp driving circuit.

### BACKGROUND OF THE INVENTION

1. Field of the Invention (Technical Field)

The present invention relates to backlights for transmissive displays and more particularly to a method and apparatus and method for replacing a fluorescent lamp with a light emitting diode (LED) module.

2. Background Art

The invention resulted from the desire to replace fluorescent lamps with LED assemblies without changing the fluorescent lamp inverter or ballast. LEDs are favorable over fluorescent lamps because LEDs have a lower failure rate, they stay bright longer than fluorescent (they last longer) and LEDs do not contain mercury, a compound considered toxic when disposed. Further, LEDs are as efficient as fluorescent lamps and continue to become more efficient because fluorescent technology is mature and improvements continue to be made with LEDs. Eventually LEDs will provide the same amount of light with less power as fluorescent lamps. The present invention provides an apparatus and method to replace the prior art fluorescent lamps with a LED assembly without any modification to the existing hardware, the assembly merely replaces the fluorescent lamp.

The majority of fluorescent lamps can be categorized as either hot cathode or cold cathode. Hot cathode fluorescent lamps have filaments while cold cathode fluorescent lamps have electrodes without filaments. Hot cathode fluorescent lamps are primarily used for general lighting and avionic displays. Cold cathode fluorescent lamps are generally used to backlight LCD displays used in computer monitors, TVs, laptops and avionic displays.

FIG. 1 shows prior art for a typical fluorescent lighting inverter or ballast circuit 10. A typical fluorescent lamp driving circuit 10 consists of an AC voltage source 12 and a current limiting impedance or ballast impedance 14. AC voltage source 12 can be household AC power, a DC to AC inverter output, or other AC source. Ballast impedance 14 is typically an inductor or capacitor but may be a resistor. A typical fluorescent lamp ballast circuit 10 operates by producing a voltage across fluorescent lamp 16 sufficient to induce an arc in lamp 16. Before the arc is established, no current flows through ballast impedance 14 so the entire voltage of AC voltage source 12 appears across fluorescent lamp 16. When an arc is induced within fluorescent lamp 16, the lamp 16 changes from a high impedance state to a low impedance state. After the arc is established, ballast impedance 14 limits the amplitude of the current that passes through lamp 16. Lamp current is typically regulated to hundreds of milliamps for hot cathode fluorescent lamps and tens of milliamps for cold cathode fluorescent lamps.

### SUMMARY OF THE INVENTION (DISCLOSURE OF THE INVENTION)

The present invention provides a means to replace a fluorescent lighting system with an LED system. By connecting the LEDs in accordance with the preferred embodiment, the fluorescent lamp driving circuit can be reused without modification. The current rating of the LEDs must be equal to or less than the current output of the fluorescent lamp driving circuit. The LED replacement lamp may consist of as few as two LEDs but multiple LEDs may be used as long as the power consumed by the LEDs does not exceed the power rating of the fluorescent lamp driving circuit.

A primary object of the present invention is to provide a means to replace a fluorescent tube lamp with an LED lamp. This system can be used for backlighting transmissive displays or as a general lighting system.

A primary advantage of the invention it that it allows a fluorescent lamp to be replaced with an LED lamp without modifying the fluorescent lamp inverter driving circuit or ballast. The fluorescent lamp driving circuit is a current source and a current source is the preferred method used to operate LEDs.

Other objects, advantages and novel features, and further scope of applicability of the present invention will be set forth in part in the detailed description to follow, taken in conjunction with the accompanying drawings, and in part will become apparent to those skilled in the art upon examination of the following, or may be learned by practice of the invention. The objects and advantages of the invention may be realized and attained by means of the instrumentalities and combinations particularly pointed out in the appended claims.

### BRIEF DESCRIPTION OF THE DRAWINGS

The accompanying drawings, which are incorporated into and form a part of the specification, illustrate several embodiments of the present invention and, together with the description, serve to explain the principles of the invention. The drawings are only for the purpose of illustrating a preferred embodiment of the invention and are not to be construed as limiting the invention. In the drawings:

FIG. 1 is depicts a prior art typical fluorescent lamp ballast.

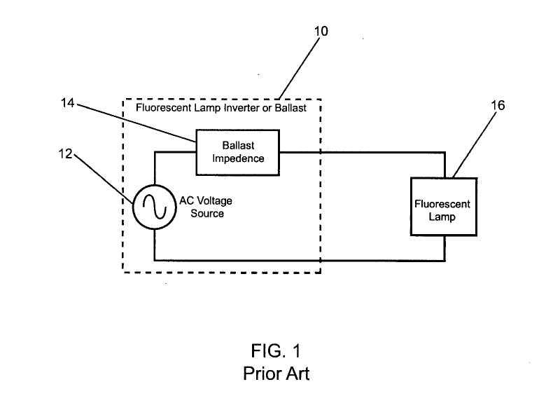

FIG. 2 is an electrical schematic of the preferred embodiment.

FIG. 3 is a graph showing current amplitude vs. time for the preferred embodiment.

### DESCRIPTION OF THE PREFERRED EMBODIMENTS

### Best Modes for Carrying Out the Invention

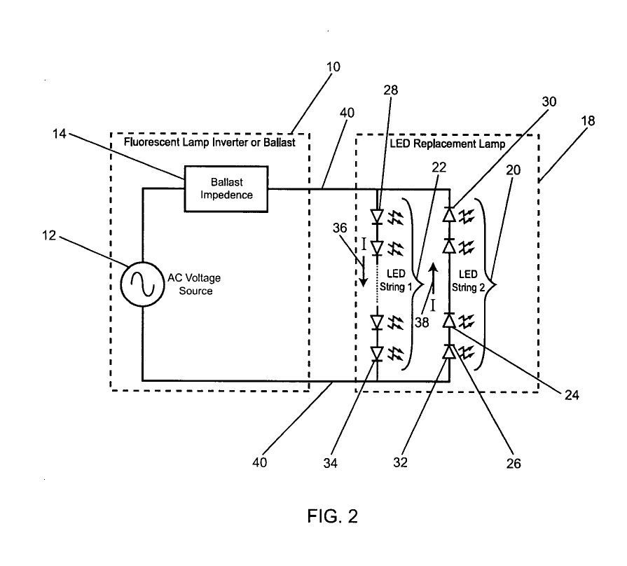

FIG. 2 is an electrical schematic of the preferred embodiment of the invention. The preferred embodiment consists primarily of the fluorescent lamp driving circuit 10 described in the prior art embodiment and an LED replacement lamp assembly 18. LED replacement lamp assembly 18 is comprised of at least two strings of LEDs 20 and 22. The number of strings must be an even number. Each string is comprised of at least one LED, but more likely multiple LEDs connected anode 24 to cathode 26 in series, as shown in FIG. 2.

First LED string 22 and second LED string 20 are connected in parallel but opposite in polarity. The anode 28 of the first LED in first string 22 is connected to cathode 30 of the last LED in second string 20. Anode 32 of the first LED in second string 20 is connected to cathode 34 of the last LED in first string 22.

When AC voltage source 12 is energized, one of the LED strings begins to conduct current. During the positive half of the AC current output of the inverter current 36 conducts through first string of LEDs 22 and the first string produces light. During the negative half of the AC current output of the inverter current 38 conducts through second LED string 20 and the second string produces light. Ballast impedance 14 serves the same purpose in the LED replacement lamp assembly 18 by limiting the current through the LED strings. Unlike the fluorescent lamp circuit 10 a high voltage does not appear across LED strings 20 and 22 because the LED impedance is low. The LED string voltage is determined by the current voltage (IV) characteristics of the LEDs.

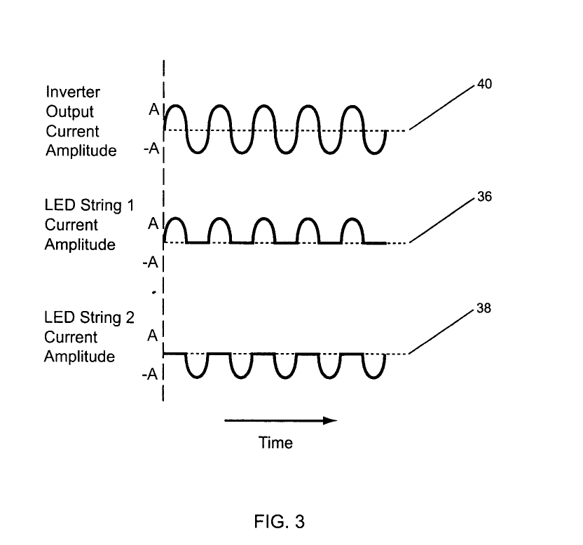

FIG. 3 is a graph depicting current amplitude vs. time for the inverter output 40, first LED string 22 and second LED string 20. FIG. 3 illustrates the inverter output current 40 is continuous while the LEDs in the first string 22 conduct current on the positive half of the output current 36 sine wave while the LEDs in LED second string 20 conduct current during the negative half of the output current 38 sine wave.

Although the invention has been described in detail with particular reference to these preferred embodiments, other embodiments can achieve the same results. Variations and modifications of the present invention will be obvious to those skilled in the art and it is intended to cover in the appended claims all such modifications and equivalents. The entire disclosures of all references, applications, patents, and publications cited above, are hereby incorporated by reference.

What is claimed is:

1. A light emitting diode assembly for use in a fluorescent light circuit, the assembly comprising:
at least one first light emitting diode;
at least one second light emitting diode, wherein an anode of the at least one first light emitting diode is connected to a cathode of at least one second light emitting diode, comprising a first connection and an anode of the at least one second light emitting diode is connected to a cathode of at least one first light emitting diode, comprising a second connection; and
a ballast from the fluorescent circuit affixed to the first connection and the second connection affixed to a power source.

2. The light emitting diode assembly of claim 1 wherein said first light emitting diode comprises a first light emitting diode string and said second light emitting diode comprises a second light emitting diode string.

3. The light emitting diode assembly of claim 2 wherein said first and second light emitting diode strings comprise a plurality of light emitting diodes connected anode to cathode in series.

4. The light emitting diode assembly of claim 1 wherein said at least one first light emitting diode and said at least one second light emitting diode each comprise a predetermined current voltage (IV) characteristic.

5. The light emitting diode assembly of claim 1 wherein said ballast comprises an impedance for limiting a current through said at least one first light emitting diode and said at least one second light emitting diode

6. A light emitting diode assembly for use in a fluorescent light circuit, the assembly comprising:
a first light emitting diode string; and
a second light emitting diode string, wherein the second light emitting diode string is connected in parallel to the first light emitting diode string in opposite polarity.

7. The light emitting diode assembly of claim 6 further comprising a fluorescent light ballast connected to a first junction of the first and second light emitting string and a power source connected to a second junction of the first and second light emitting string.

8. The light emitting diode assembly of claim 7 wherein said ballast comprises an impedance for limiting a current through said at least one first light emitting diode string and said at least one second light emitting diode string.

9. The light emitting diode assembly of claim 6 wherein said first and second light emitting diode strings comprise a plurality of light emitting diodes connected anode to cathode in series.

10. The light emitting diode assembly of claim 6 wherein each light emitting diode from said first light emitting diode string and said second light emitting diode string comprise a predetermined current voltage (IV) characteristic.

11. A method of providing light from light emitting diodes in a fluorescent light circuit, the method comprising the steps of:
providing a first light emitting diode string and a second light emitting diode string, wherein the second light emitting diode string is connected in parallel to the first light emitting diode string in opposite polarity;
affixing a first junction of the first and second light emitting diode strings to a fluorescent circuit ballast and a second junction to a power source; and
energizing the power source.

12. The method of claim 11 wherein the step of energizing comprised conducting a current through the first light emitting diode string during a positive half of the power source and conducting the current through the second light emitting diode string during a negative half of the power source.

13. The method of claim 11 wherein the step of providing comprises selecting a predetermined current voltage (IV) characteristic for each light emitting diode from the first and second light emitting diode strings.
